(19) United States
(12) Patent Application Publication
(10) Pub. No.: US 2015/0255813 A1
(43) Pub. Date: Sep. 10, 2015

(54) Secondary Battery Type Fuel Cell System

(71) Applicant: Konica Minolta, Inc., Chiyoda-Ku, Tokyo (JP)

(72) Inventor: Atsuhiro Noda, Chiyoda-ku (JP)

(21) Appl. No.: 14/429,843

(22) PCT Filed: Sep. 12, 2013
(86) PCT No.: PCT/JP2013/074682

§ 371 Date: Mar. 20, 2015

(30) Foreign Application Priority Data
Oct. 3, 2012 (JP) 2012-221618

(51) Int. Cl. H01M 8/04; H01M 8/06

(52) U.S. Cl. CPC H01M 8/04089; H01M 8/0656; H01M 8/0606

(57) ABSTRACT

A secondary battery type fuel cell system comprising: a fuel generating member, a power generation electrolysis portion that has a power generating function and an electrolysis function, a gas flow path that circulates a gas between the fuel generating member and the power generation electrolysis portion, a gas moving device that sends an oxidant gas to the power generation electrolysis portion, and a gas moving device controller that controls an amount of gas-flow produced by the gas moving device. The gas moving device controller performs control such that an amount of gas-flow produced by the gas moving device at a time when the power generation electrolysis portion is performing electrolysis becomes less than an amount of gas-flow produced by the gas moving device at a time when the power generation electrolysis portion is performing power generation.

### TECHNICAL FIELD

The present invention relates to a secondary battery type fuel cell system that is able to perform not only a power generation operation but also a charge operation.

### BACKGROUND ART

A fuel cell has typically a cell structure in which a solid polymer electrolyte membrane using a solid polymer ion exchange membrane, a solid oxide electrolyte membrane using yttria stabilized zirconia (YSZ), or the like is sandwiched between a fuel electrode (anode) and an oxidant electrode (cathode) from both sides. And, a fuel gas flow path for supplying a fuel gas (e.g., hydrogen) to the fuel electrode and an oxidant gas flow path for supplying an oxidant gas (e.g., oxygen or air) to the oxidant electrode are formed, the fuel gas and the oxidant gas are supplied respectively to the fuel electrode and the oxidant electrode via these flow paths, whereby power generation is performed.

The fuel cell has by nature a high efficiency in derivable power energy; accordingly, the fuel cell has a form of power generation that is not only useful to energy saving but also excellent environmentally, and is expected as a key to solution to global energy and environmental problems.

### CITATION LIST

### Patent Literature

Patent Document 1: JP-A-H11-501448

Patent Document 2: International Publication WO/2012/043271

### SUMMARY OF INVENTION

### Technical Problem

The patent document 1 and patent document 2 each disclose a secondary battery type fuel cell system that uses a combination of a solid oxide type fuel cell and a hydrogen generating member which generates hydrogen by a chemical reaction and is renewable by a reduction reaction. In the above secondary battery type fuel cell system, the hydrogen generating member generates hydrogen during a power generation period of the system, and the hydrogen generating member is renewed during a charge operation period of the system.

During the power generation operation period, it is required to output a predetermined amount of electric power from the solid oxide type fuel cell. However, if an oxidant gas supplied to the oxidant electrode of the solid oxide type fuel cell runs short, a power generation amount of the solid oxide type fuel cell runs short even if a fuel gas is sufficiently supplied to the fuel electrode of the solid oxide type fuel cell. Accordingly, it is desirable to provide the secondary battery type fuel cell system with a gas moving device that sends the oxidant gas to the oxidant electrode of the solid oxide type fuel cell.

However, energy is necessary for a drive of the gas moving device; accordingly, from the viewpoint of raising energy efficiency, it is necessary to take caution such that wasteful energy is not consumed by the drive of the gas moving device.

In light of the above situation, it is an object of the present invention to provide a secondary battery type fuel cell system that has a high energy efficiency.

### Solution to Problem

To achieve the above object, a secondary battery fuel cell system according to the present invention has a structure that comprises: a fuel generating member that generates a fuel gas by a chemical reaction and is renewable by a reverse reaction of the chemical reaction; a power generation electrolysis portion that has: a power generating function to perform power generation by using an oxidant gas and the fuel gas supplied from the fuel generating member; and an electrolysis function to electrolyze a product of the reverse reaction which is supplied from the fuel generating member during a renewal period of the fuel generating member; a gas flow path that circulates a gas between the fuel generating member and the power generation electrolysis portion; a gas moving device that sends the oxidant gas to the power generation electrolysis portion, and a gas moving device controller that controls an amount of gas-flow produced by the gas moving device; wherein the gas moving device controller performs control such that an amount of gas-flow produced by the gas moving device at a time when the power generation electrolysis portion is performing electrolysis becomes less than an amount of gas-flow produced by the gas moving device at a time when the power generation electrolysis portion is performing power generation. In the meantime, the power generation electrolysis portion may have a structure which includes, for example, a fuel cell that switches a power generation operation for performing the power generation by using the fuel gas supplied from the fuel generating member and an electrolysis operation for electrolyzing the product of the reverse reaction which is supplied from the fuel generating member during the renewal period of the fuel generating member, or may have a structure which, for example, includes separately: a fuel cell that performs the power generation by using the fuel gas supplied from the fuel generating member; and an electrolysis apparatus that electrolyzes the product of the reverse reaction which is supplied from the fuel generating member during the renewal period of the fuel generating member.

### Advantageous Effects of Invention

According to the secondary battery type fuel cell of the present invention, the amount of gas-flow produced by the gas moving device at the time when the power generation electrolysis portion is performing the electrolysis is controlled to become less than the amount of gas-flow produced by the gas moving device at the time when the power generation electrolysis portion is performing the power generation; accordingly, it is possible to obviate the consumption of wasteful energy for the drive of the gas moving device and raise the energy efficiency during the electrolysis period of the power generation electrolysis portion.

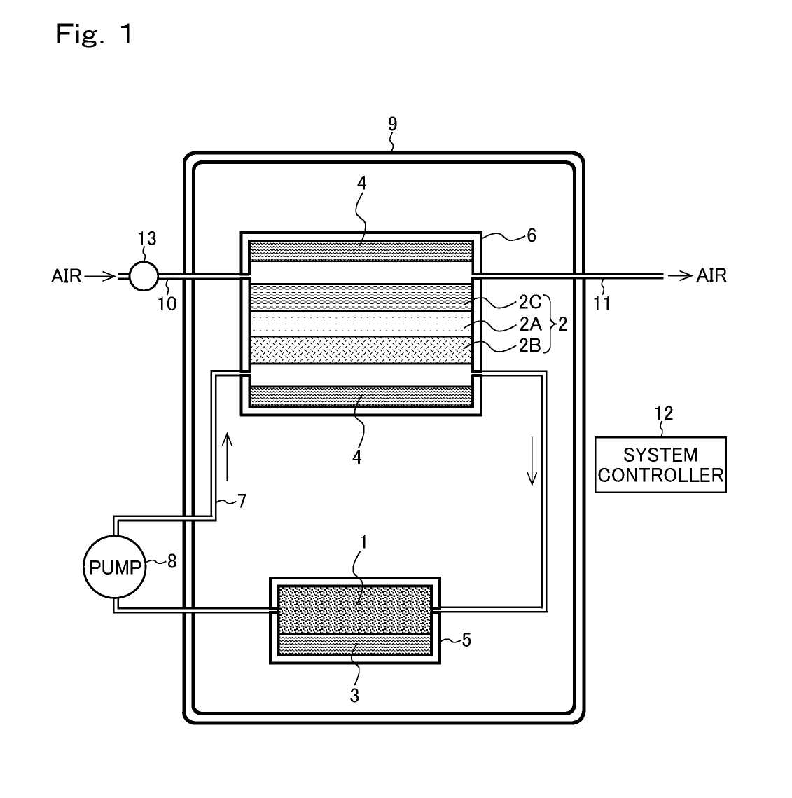

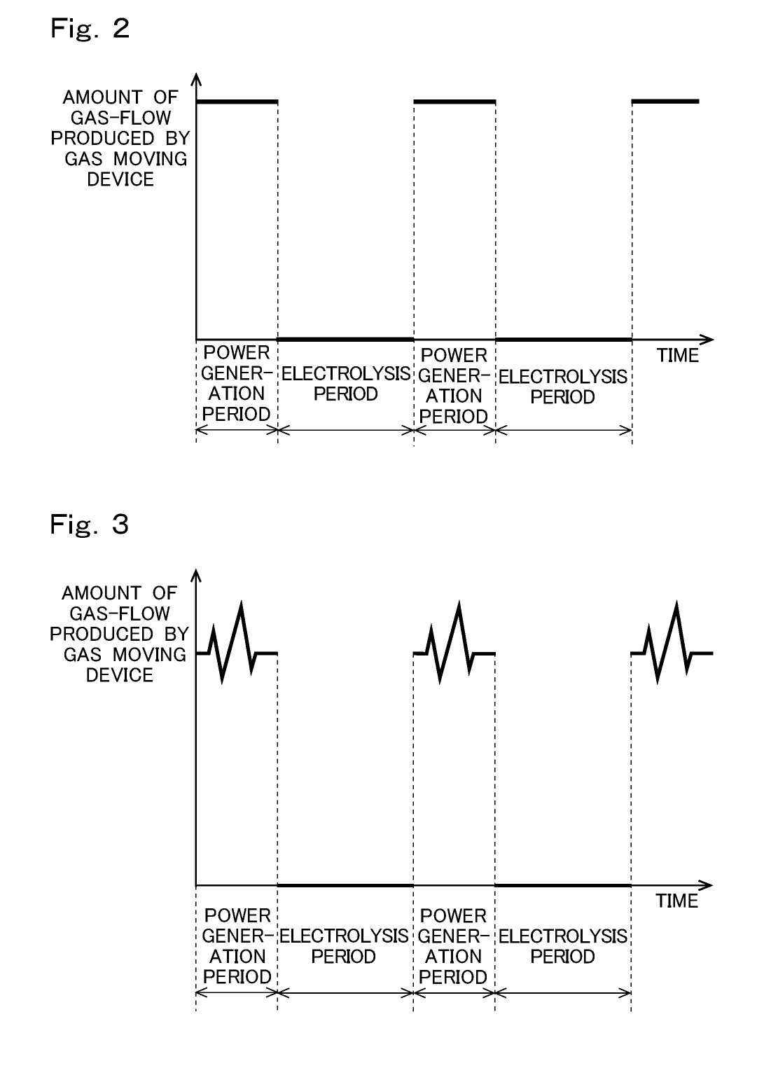

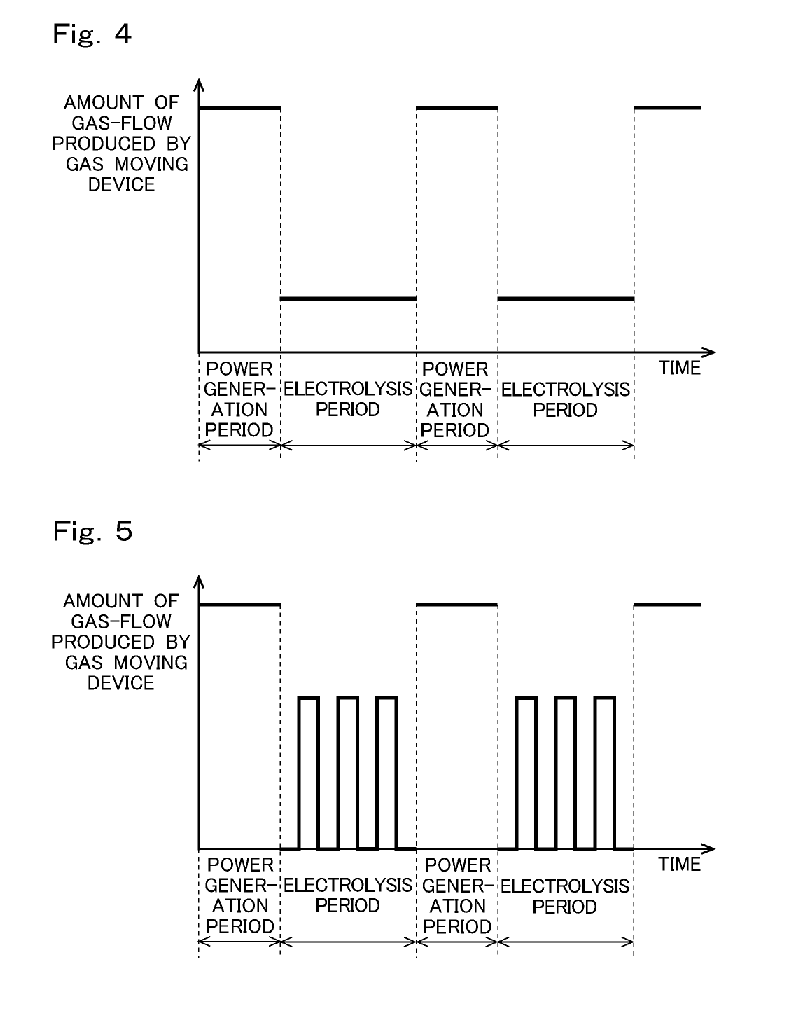

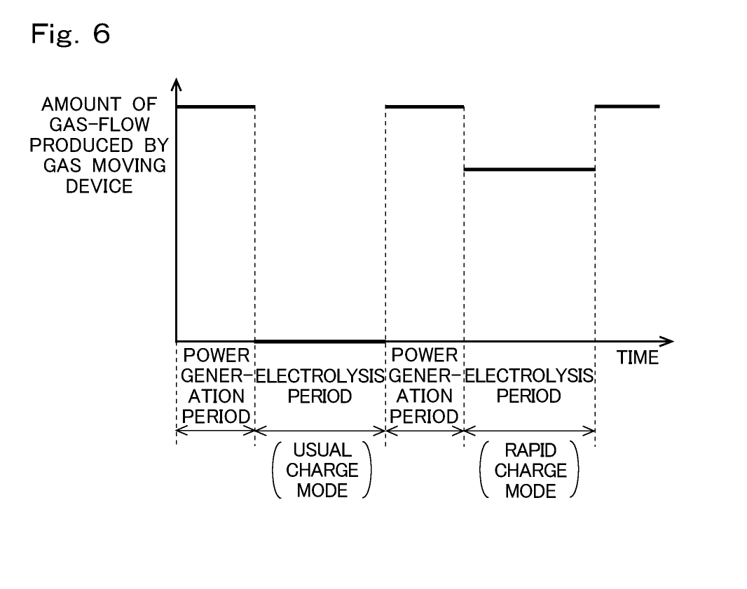

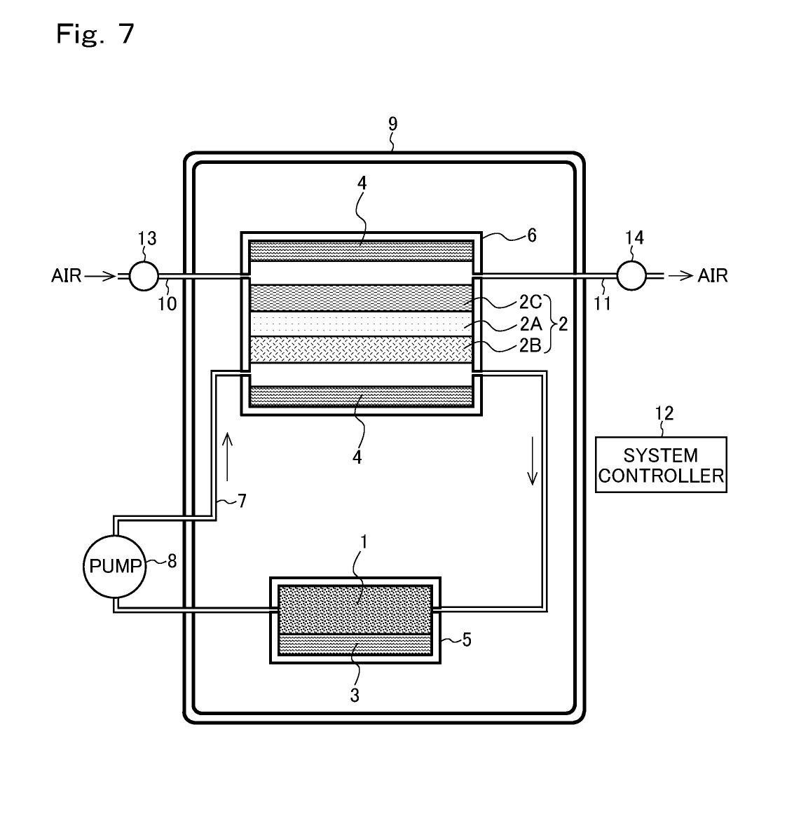

### BRIEF DESCRIPTION OF DRAWINGS

[FIG. 1] is a diagrammatic view showing a schematic structure of a secondary battery type fuel cell system according to a first embodiment of the present invention.

[FIG. 2] is a view showing an amount of gas-flow produced by a gas moving device in a first control example.

[FIG. 3] is a view showing an amount of gas-flow produced by a gas moving device in a second control example.

[FIG. 4] is a view showing an amount of gas-flow produced by a gas moving device in a third control example.

[FIG. 5] is a view showing an amount of gas-flow produced by a gas moving device in a fourth control example.

[FIG. 6] is a view showing an amount of gas-flow produced by a gas moving device in a fifth control example.

[FIG. 7] is a diagrammatic view showing a schematic structure of a secondary battery type fuel cell system according to a second embodiment of the present invention.

### DESCRIPTION OF EMBODIMENTS

Embodiments of the present invention are described hereinafter with reference to the drawings. In the meantime, the present invention is not limited to the embodiments described later.

### First Embodiment

FIG. 1 shows a is a schematic structure of a secondary battery type fuel cell system according to a first embodiment of the present invention. The secondary battery type fuel cell system according to the present embodiment includes: a fuel generating member 1; a fuel cell portion 2; a heater 3 that heats the fuel generating member 1; a heater 4 that heats the fuel cell portion 2; a container 5 that houses the fuel generating member 1 and the heater 3; a container 6 that houses the fuel cell portion 2 and the heater 4; a pipe 7 (gas flow path) that circulates a gas between the fuel generating member 1 and the fuel cell portion 2; a pump 8 that forcibly circulates a gas between the furl generating member 1 and the fuel cell portion 2; a heat insulating container 9; a pipe 10 (gas flow path) that supplies air as an oxidant to an air electrode 2C that is an oxidant electrode of the fuel cell portion 2; a pipe 11 (gas flow path) that discharges air from the air electrode 2C of the fuel cell portion 2; a system controller 12 that controls an entirety of the system; and a gas moving device 13 (first gas moving device) that sends air to the air electrode 2C of the fuel cell portion 2. The heat insulating container 9 houses the containers 5 and 6, and a part of each of the pipes 7, 10, and 11.

In the meantime, to prevent the drawings from becoming complicated, illustration of a power line for transmitting electric power and a control line for transmitting a control signal are skipped. Besides, a temperature sensor and the like may be disposed around the fuel generating member 1 and the fuel cell portion 2. Besides, instead of the pump 8, other circulators such as, for example, a compressor, a fan, a blower and the like may be used.

As the gas moving device 13, there are, for example, a compressor, a fan, a blower and the like. In a case where a fan is used as the gas moving device 13, it is possible to supply a constant flow of air to the air electrode 2C of the fuel cell portion 2, and in a case where a gas moving device of diaphragm type is used as the gas moving device 13, it is possible to supply a substantially constant flow of air to the air electrode 2C of the fuel cell portion 2 by driving the diaphragm at a high speed. In the meantime, in the present embodiment, the gas moving device 13 is disposed on the pipe 10, but may be disposed on the pipe 11.

As the fuel generating member 1, a member is usable, which uses a metal as a base material, to a surface of which a metal or a metal oxide is added; generates a fuel gas (e.g., hydrogen) by an oxidation reaction with an oxidant gas (e.g., water vapor); and is renewable by a reduction reaction with a reducible gas (e.g., hydrogen). As the metal of the base material, there are, for example, Ni, Fe, Pd, V, Mg, and an alloy that uses these as a matrix, and among others, Fe is especially preferable because it is inexpensive and easy to machine. Besides, as the added metal, there are Al, Rh, Pd, Cr, Ni, Cu, Co, V, and Mo, and as the added metal oxide, there are SiO₂, TiO₂ and the like. However, the metal used for the base material and the added metal are not the same as each other. In the meantime, in the present embodiment, as the fuel generating member 1, a fuel generating member, which uses Fe as a main body, is used.

The fuel generating member using Fe as the main boy can generate hydrogen as a fuel gas (reducible gas) by consuming water vapor as an oxidant gas by an oxidation reaction indicated by the following formula (1).

4H₂O+3Fe→4H₂+Fe₃O₄ (1)

If the oxidation reaction of the iron indicated in the above formula (1) advances, a change from the iron to iron oxide advances and a remaining amount of the iron reduces. However, by a reverse reaction of the above formula (1), namely, a reduction reaction indicated by the following formula (2), it is possible renew the fuel generating member 1. In the meantime, it is also possible to perform the oxidation reaction of the iron indicated by the above formula (1) and the reduction reaction of the following formula (2) at a low temperature under 600° C.

4H₂+Fe₃O₄→3Fe+4H₂O (2)

In the fuel generating member 1, it is desirable that a surface area per unit volume is enlarged to raise its reaction characteristic. As a measure to increase the surface area per unit volume of the fuel generating member 1, for example, the main body of the fuel generating member 1 may be broken into micro-particles and the micro-particles may be molded. As the breaking method, there is a method in which for example, a ball mill or the like is used to pulverize particles. Further, the surface area of the micro-particles may be further increased by generating cracks in the micro-particles by a mechanical method or the like, or the surface area of the micro-particles may be further increased by roughing the surface of the micro-particles by acid treatment, alkaline treatment, sandblasting or the like.

The fuel generating member 1 may be produced by, for example, forming the micro-particles into pellet-like pieces and embedding many of these pieces in a space, or may be produced by hardening the micro-particles with gaps left somewhat to allow a gas to pass through.

As shown in FIG. 1, the fuel cell portion 2 has an MEA structure (Membrane Electrode Assembly) in which a fuel electrode 2B and an air electrode 2C, that is, an oxidant electrode are connected to both surfaces of an electrolyte membrane 2A. In the meantime, FIG. 1 shows the structure in which only one MEA is disposed; however, a plurality of MEAs may be disposed, or further the plurality of MEAs may be laminated.

As a material of the electrolyte membrane 2A, it is possible to use, for example, a solid oxide electrolyte that uses yttria stabilized zirconia (YSZ), besides, for example, it is possible to use a solid polymer electrolyte such as Nafion (trademark of Du Pont), cation electro-conductive polymer, anion electro-conductive polymer, or the like; however, these are not limiting, and materials, which transmit hydrogen ions, oxygen ions, hydroxide ions or the like and satisfy the electrolyte characteristics of the fuel cell, may be used. In the meantime, in the present embodiment, as the electrolyte membrane 2A, a solid oxide electrolyte membrane, which utilizes an electrolyte, for example, yttria stabilized zirconia (YSZ), that transmits oxygen ions or hydroxide ions, is used.

The electrolyte membrane 2A can be formed by using CVD-EVD (Chemical Vapor Deposition-Electrochemical Vapor Deposition) or the like in the case of a solid oxide electrolyte, and can be formed by using an applying method or the like in the case of a solid polymer electrolyte.

The fuel electrode 2B and the air electrode 2C can each have a structure which includes, for example, a catalyst layer in contact with the electrolyte membrane 2A and a diffusion electrode laminated on the catalyst layer. As the catalyst layer, for example, it is possible to use a material or the like in which platinum black or platinum alloy is borne by carbon black. Besides, as a material of the diffusion electrode of the fuel electrode 2B, it is possible to use, for example, carbon paper, Ni—Fe based cermet, Ni-YSZ based cermet or the like. Besides, as a material of the diffusion electrode of the air electrode 2C, it is possible to use, for example, carbon paper, a La—Mn—O based compound, a La—Co—Ce based compound or the like. The fuel electrode 2B and the air electrode 2C can be each formed by using deposition or the like, for example.

In the following description, the case where hydrogen is used as the fuel gas is described.

During a power generation period of the secondary battery type fuel cell system according to the present embodiment, the fuel cell portion 2 is electrically connected to an external load (not shown) by control by the system controller 12. During the power generation period of the secondary battery type fuel cell system according to the present embodiment, in the fuel cell portion 2, a reaction of the following formula (3) occurs at the fuel electrode 2B.

H₂+O²⁻→H₂O+2e⁻ (3)

The electrons generated by the reaction of the above formula (3) reach the air electrode 2C via the external load (not shown), so that a reaction of the following formula (4) occurs at the air electrode 2C.

½O₂+2e−→O²⁻ (4)

And, the oxygen ions generated by the reaction of the above formula (4) reach the fuel electrode 2B via the electrolyte membrane 2A. By repeating the above series of reactions, the fuel cell portion 2 performs the power generation operation. Besides, as understood from the above formula (3), during the power generation period of the secondary battery type fuel cell system according to the present embodiment, H₂ is consumed at the fuel electrode 2B to generate H₂O.

From the above formulas (3) and (4), the reaction at the fuel cell portion 2 during the power generation operation period of the secondary battery type fuel cell system according to the present embodiment occurs as indicated by the following formula (5).

H₂+½O₂→H₂O (5)

On the other hand, by the oxidation reaction indicated by the above formula (1), the fuel generating member 1 consumes H₂O, which is generated at the fuel electrode 2B of the fuel cell portion 2 during the power generation period of the secondary battery type fuel cell system according to the present embodiment, and thereby generates H₂.

If the oxidation reaction of the iron indicated by the above formula (1) advances, the change from the iron to the iron oxide advances and the remaining amount of the iron reduces. However, it is possible to renew the fuel generating member 1 by the reduction reaction indicated by the above formula (2), and it is possible to charge the secondary battery type fuel cell system according to the present embodiment.

During a charge period of the secondary battery type fuel cell system according to the present embodiment, the fuel cell portion 2 is connected to an external power source (not shown) by the control by the system controller 12. At the fuel cell portion 2, during the charge period of the secondary battery type fuel cell system according to the present embodiment, an electrolysis reaction, which is indicated by the following formula (6) and a reverse reaction of the above formula (5), occurs, H₂O is consumed at the fuel electrode 2B to generate H₂, and at the fuel generating member 1, the reduction reaction indicated by the above formula (2) occurs, and H₂ generated at the fuel electrode 2B of the fuel cell portion 2 is consumed to generate H₂O.

H₂O→H₂+½O₂ (6)

As described above, during the power generation operation period of the secondary battery type fuel cell system according to the present embodiment, H₂ is consumed at the fuel electrode 2B to generate H₂O, and during the charge period of the secondary battery type fuel cell system according to the present embodiment, H₂O is consumed at the fuel electrode 2B to generate H₂. And, a partial-pressure ratio of H₂ and H₂O as the gases supplied to the fuel electrode 2B of the fuel cell portion 2 is decided by an equilibrium state of H₂ and H₂O at the fuel generating member 1. This equilibrium state depends on a temperature of the fuel generating member 1. For example, under an environment of 600° C., the partial-pressure ratio of H₂ and H₂O in the equilibrium state is 75:25. In this case, during the power generation operation period of the secondary battery type fuel cell system according to the present embodiment, 75% of the gas supplied to the fuel electrode 2B of the fuel cell portion 2 is usable as the fuel gas, and during the charge operation period of the secondary battery type fuel cell system according to the present embodiment, 25% of the gas supplied to the fuel electrode 2B of the fuel cell portion 2 is usable for the electrolysis. In other words, under the environment of 600° C., the amount of the gas reacting at the fuel electrode 2B of the fuel cell portion 2 during the power generation operation period becomes three times larger than that during the charge operation period. Accordingly, during the power generation operation period, it is possible to increase the power generation amount by supplying air corresponding to the fuel gas amount to the air electrode 2C.

Besides, there are many cases where the fuel cell portion 2 capable of performing the power generation reaction and the electrolysis reaction is usually designed such that the electrode, the electrolyte, the catalyst and the like are optimum for the power generation reaction. Because of this, there are many cases where the power generation reaction at the fuel cell portion 2 has a better efficiency and faster reaction velocity than the electrolysis reaction at the fuel cell portion 2.

As described above, it is possible to prompt a faster reaction during the power generation operation period than during the charge operation period by supplying a larger amount of air to the air electrode 2C. Besides, usually, it is necessary to generate a constant amount of power in a short time during the power generation operation. However, it is sufficient to perform the charge slowly during night or the like. Accordingly, in the secondary battery type fuel cell system according to the present embodiment, the system controller 12 controls the gas moving device 13 such that an amount of gas-flow produced by the gas moving device 13 at the time when the fuel cell portion 2 is performing the electrolysis becomes less than an amount of gas-flow produced by the gas moving device 13 at the time when the fuel cell portion 2 is performing the power generation. In this way, when the fuel cell portion 2 is performing the electrolysis, it is possible to obviate consumption of wasteful energy for the drive of the gas moving device 13 and raise energy efficiency.

### <First Control Example>

In the present control example, as shown in FIG. 2, the system controller 12 controls the amount of gas-flow produced by the gas moving device 13 at a constant amount (necessary and sufficient amount when the power generation amount of the fuel cell portion 2 is maximum) when the fuel cell portion 2 is performing the power generation, and stops the gas moving device 13 to control the amount of gas-flow produced by the gas moving device 13 at zero when the fuel cell portion 2 is performing the electrolysis.

### <Second Control Example>

In the present control example, as shown in FIG. 3, the system controller 12 controls the amount of gas-flow produced by the gas moving device 13 in accordance with the power generation amount of the fuel cell portion 2 when the fuel cell portion 2 is performing the power generation, and stops the gas moving device 13 to control the amount of gas-flow produced by the gas moving device 13 at zero when the fuel cell portion 2 is performing the electrolysis.

### <Third Control Example>

In the present control example, as shown in FIG. 4, the system controller 12 controls the amount of gas-flow produced by the gas moving device 13 at a constant amount (necessary and sufficient amount when the power generation amount of the fuel cell portion 2 is maximum) when the fuel cell portion 2 is performing the power generation, and controls the amount of gas-flow produced by the gas moving device 13 at a constant amount less than that during the power generation period when the fuel cell portion 2 is performing the electrolysis.

When the fuel cell portion 2 is performing the electrolysis, if the oxygen generated at the air electrode 2C is not discharged from the pipe 11, an oxygen concentration in the air electrode 2C rises. If the oxygen concentration in the air electrode 2C rises too much, the electrolysis reaction becomes difficult to occur. Usually, because of natural diffusion of the oxygen generated at the air electrode 2C and pressure rise due to the oxygen generated at the air electrode 2C, the oxygen generated by the air electrode 2C is smoothly discharged from the pipe 11. However, as in the present control example, by making the gas moving device 13 operate when the fuel cell portion 2 is performing the electrolysis, it is possible to discharge more surely the oxygen generated by the air electrode 2C from the pipe 11.

In the meantime, in the present control example, like in the second control example, the system controller 12 may control the amount of gas-flow produced by the gas moving device 13 in accordance with the power generation amount of the fuel cell portion 2 when the fuel cell portion 2 is performing the power generation.

### <Fourth Control Example>

In the present control example, as shown in FIG. 5, the system controller 12 controls the amount of gas-flow produced by the gas moving device 13 at a constant amount (necessary and sufficient amount when the power generation amount of the fuel cell portion 2 is maximum) when the fuel cell portion 2 is performing the power generation, and drives the gas moving device 13 intermittently when the fuel cell portion 2 is performing the electrolysis and thereby performs control such that an average amount of gas-flow produced by the gas moving device 13 becomes less than the amount of blown wind during the power generation period.

The intermittent drive of the gas moving device 13 may be performed, for example, in such a way that a rising degree of the oxygen concentration in the air electrode 2C is grasped beforehand by an experiment, a simulation and the like, and the drive and stop of the gas moving device 13 is switched at a predetermined timing that is set beforehand in accordance with the rising degree of the oxygen concentration in the air electrode 2C; or a sensor for detecting the oxygen concentration is disposed around the air electrode 2C, and the drive and stop of the gas moving device 13 is switched based on an output from the sensor.

In the meantime, unlike FIG. 5, the amount of gas-flow produced by the gas moving device 13 at the time when the fuel cell portion 2 is performing the power generation may be the same as the amount of gas-flow produced by the gas moving device 13 when the fuel cell portion 2 is performing the electrolysis and the gas moving device 13 is being driven.

Besides, in the present control example, like in the second control example, the system controller 12 may control the amount of gas-flow produced by the gas moving device 13 in accordance with the power generation amount of the fuel cell portion 2 when the fuel cell portion 2 is performing the power generation.

### <Fifth Control Example>

In the present control example, as shown in FIG. 6, the system controller 12 controls the amount of gas-flow produced by the gas moving device 13 at a constant amount (necessary and sufficient amount when the power generation amount of the fuel cell portion 2 is maximum) when the fuel cell portion 2 is performing the power generation, and controls the amount of gas-flow produced by the gas moving device 13 in accordance with the electrolysis amount of the fuel cell portion 2 when the fuel cell portion 2 is performing the electrolysis.

In the present control example, the system controller 12 has a usual charge mode and a rapid charge mode. In the rapid charge mode, the system controller 12 circulates a gas amount from the pump 8 more than that in the usual charge mode, increases power to be supplied to the fuel cell portion 2, and raises the amount of gas-flow produced by the gas moving device 13. In this way, it is possible to surely discharge the oxygen generated by the air electrode 2C from the pipe 11 at a generation speed in the rapid charge mode faster than that in the usual charge mode. In this case, in the usual charge mode, as shown in FIG. 6, the gas moving device 13 may be stopped to control the amount of gas-flow produced by the gas moving device 13 at zero, or to control the amount of gas-flow produced by the gas moving device 13 at a constant amount less than that in the rapid charge mode.

In the meantime, in the present control example, like in the fourth control example, the system controller 12 may drive intermittently the gas moving device 13 when the fuel cell portion 2 is performing the electrolysis.

Besides, in the present control example, like in the second control example, the system controller 12 may control the amount of gas-flow produced by the gas moving device 13 in accordance with the power generation amount of the fuel cell portion 2 when the fuel cell portion 2 is performing the power generation.

### Second Embodiment

FIG. 7 shows a is a schematic structure of a secondary battery type fuel cell system according to a second embodiment of the present invention. In the meantime, in FIG. 7, the same components as FIG. 1 are indicated by the same reference numbers and detailed description is skipped. The secondary battery type fuel cell system according to the present embodiment has a structure in which a gas moving device 14 (second gas moving device) is added to the secondary battery type fuel cell system according to the first embodiment. The gas moving device 14 is disposed on the pipe 11 and controlled by the system controller 12. In the meantime, unlike FIG. 7, the gas moving device 14 may be disposed on the pipe 10.

Energy conversion efficiency of a gas moving device changes depending on an amount of blown wind; accordingly, in a case where the amount of blown wind is large, it is desirable to select a gas moving device that has the highest efficiency when the amount of blown wind is large, and in a case where the amount of blown wind is small, it is desirable to select a gas moving device that has the highest efficiency when the amount of blown wind is small.

The present embodiment uses a gas moving device, which has the highest efficiency when the amount of blown wind is large, as the gas moving device 13, and uses a gas moving device, which has the highest efficiency when the amount of blown wind is small, as the gas moving device 14. And, the system controller 12 modifies and fulfills any one of the third to fifth control examples of the first embodiment. Specifically, when the fuel cell portion 2 is performing the power generation, the gas moving device 13, which has the highest efficiency when the amount of blown wind is large, is made to operate, and when the fuel cell portion 2 is performing the electrolysis, the gas moving device 14, which has the highest efficiency when the amount of blown wind is small, is made to operate (hereinafter, the gas moving device, which has the highest efficiency in accordance with the amount of blown wind, is called a main gas moving device). In this way, compared with the first embodiment, the present embodiment can use efficiently energy utilized to operate the gas moving device; accordingly, it is possible to raise the energy efficiency of the fuel cell system. Besides, the number of gas moving devices is not limited to two, but three or more gas moving devices having different efficiencies may be combined with each other.

In the meantime, the operations of the gas moving devices other than the main gas moving device may be stopped during the power generation period or charge period, or may not be stopped necessarily completely. Besides, in a case where the gas moving device is a fan, even if the operation is stopped, the gas passes through a gap of the fan to some extent. However, if the operation of the blower is stopped with a passage aperture for the gas closed, the gas flow is stopped there. Because of this, as shown in FIG. 7, in a case where the gas moving device 13 and the gas moving device 14 are connected in series with the fuel cell portion 2, the gas in the air electrode is not discharged. Therefore, in the case where the blower is used, the control may be performed by the system controller 12 such that the operation is stopped with the passage aperture for the gas opened. Or, if a structure is employed in which the gas moving device 13 and the gas moving device 14 are connected in parallel with the fuel cell by their respective pipes (gas paths), even if the operations of the gas moving devices other than the main gas moving device are stopped to halt the gas flow, it is possible to discharge the gas in the air electrode by the operation of the main gas moving device. As described above, combinations of types and structures of various gas moving devices are conceivable.

When the system controller 12 modifies and fulfills any one of the third to fifth control examples of the first embodiment, the system controller 12 may control the amount of gas-flow produced by the gas moving device 13 in accordance with the power generation amount of the fuel cell portion 2 when the fuel cell portion 2 is performing the power generation. Besides, when the system controller 12 modifies and fulfills any one of the third to fifth control examples of the first embodiment, the system controller 12 may control the amount of gas-flow produced by the gas moving device 13 in accordance with the electrolysis amount of the fuel cell portion 2 when the fuel cell portion 2 is performing the electrolysis.

Besides, when the system controller 12 modifies and fulfills the fifth control example of the first embodiment, the system controller 12 may drive intermittently the gas moving device 14 when the fuel cell portion 12 is performing the electrolysis.

### Others

In each embodiment described above, as the electrolyte membrane 2A of the fuel cell portion 2, a solid oxide electrolyte is used to generate water at the fuel electrode 2B during the power generation. According to this structure, the water is generated on the side where the fuel generating member 1 is disposed; accordingly, it is advantageous to simplification and size reduction of the apparatus. On the other hand, like the fuel cell disclosed in JP-A-2009-99491, it is also possible to use a solid polymer electrolyte as the electrolyte membrane 2A of the fuel cell portion 2 that transmits hydrogen ions. However, in this case, during the power generation, the water is generated at the air electrode 2C that is the oxidant electrode of the fuel cell portion 2; accordingly, a flow path for conducting the water to the fuel generating member 1 may be disposed. Besides, in each embodiment described above, one fuel cell portion 2 performs both the power generation and the electrolysis of water; however, a structure may be employed, in which the fuel cell (e.g., solid oxide fuel cell dedicated to the power generation) and the electrolysis device (e.g., solid oxide fuel cell dedicated to the electrolysis of water) of water are connected in parallel with the fuel generating member 1 on the gas flow path.

Besides, in each embodiment described above, hydrogen is used as the fuel gas for the fuel cell portion 2; however, a reducible gas other than hydrogen such as carbon monoxide, hydrocarbon or the like may be used as the fuel gas for the fuel cell portion 2.

Besides, in each embodiment described above, air is used as the oxidant gas; however, an oxidant gas other than air may be used.

The secondary battery type fuel cell system described above has a structure (first structure) which includes: a fuel generating member that generates a fuel gas by a chemical reaction and is renewable by a reverse reaction of the chemical reaction; a power generation electrolysis portion that has a power generating function to perform power generation by using an oxidant gas and the fuel gas supplied from the fuel generating member and an electrolysis function to electrolyze a product of the reverse reaction which is supplied from the fuel generating member during a renewal period of the fuel generating member; a gas flow path that circulates a gas between the fuel generating member and the power generation electrolysis portion; a gas moving device that sends the oxidant gas to the power generation electrolysis portion, and a gas moving device controller that controls an amount of gas-flow produced by the gas moving device; wherein the gas moving device controller performs control such that an amount of gas-flow produced by the gas moving device at a time when the power generation electrolysis portion is performing electrolysis becomes less than an amount of gas-flow produced by the gas moving device at a time when the power generation electrolysis portion is performing power generation. In the meantime, the power generation electrolysis portion may have a structure that includes, for example, a fuel cell that switches: the power generation operation which uses the fuel gas supplied from the fuel generating member; and the electrolysis operation which electrolyzes a product of the reverse reaction supplied from the fuel generating member during the renewal period of the fuel generating member. Besides the power generation electrolysis portion may have a structure that includes, for example, separately: a fuel cell which performs the power generation by using the fuel gas supplied from the fuel generating member; and an electrolysis device which electrolyzes the product of the reverse reaction supplied from the fuel generating member during the renewal period of the fuel generating member.

Besides, in the secondary battery type fuel cell system having the first structure, a structure (second structure) may be employed, in which when the power generation electrolysis portion is performing the electrolysis, the gas moving device controller stops the operation of the gas moving device.

Besides, in the secondary battery type fuel cell system having the first or second structure, a structure (third structure) may be employed, in which when the power generation electrolysis portion is performing the power generation, the gas moving device controller controls the amount of gas-flow produced by the gas moving device in accordance with the power generation amount of the power generation electrolysis portion.

Besides, in the secondary battery type fuel cell system having any one of the first to third structures, a structure (fourth structure) may be employed, in which when the power generation electrolysis portion is performing the electrolysis, the gas moving device controller drives the gas moving device intermittently.

Besides, in the secondary battery type fuel cell system having the fourth structure, a structure (fifth structure) may be employed, in which the gas moving device controller performs control such that the amount of blown wind during a drive period in the intermittent drive of the gas moving device becomes less than the amount of gas-flow produced by the gas moving device at the time when the power generation electrolysis portion is performing the power generation.

Besides, in the secondary battery type fuel cell system having the fifth structure, a structure (sixth structure) may be employed, in which the power generation electrolysis portion has an oxidant electrode to which the oxidant gas is supplied; and the gas moving device controller switches the drive and stop of the gas moving device based on an oxygen concentration in the oxidant electrode.

Besides, in the secondary battery type fuel cell system having the first structure, a structure (seventh structure) may be employed, in which when the power generation electrolysis portion is performing the electrolysis, the gas moving device controller controls the amount of gas-flow produced by the gas moving device based on an electrolysis amount of the power generation electrolysis portion.

Besides, in the secondary battery type fuel cell system having any one of the first to seventh structures, a structure (eighth structure) may be employed, in which the gas moving device is used as a first gas moving device; and a second gas moving device, which discharges an oxidant gas generated by electrolysis from the power generation electrolysis portion, is further included; the first gas moving device is a gas moving device that has a high efficiency at a large amount of blown wind, and the second gas moving device is a gas moving device that has a high efficiency at a small amount of blown wind; the gas moving device controller also controls an amount of gas-flow produced by the second gas moving device; makes the first gas moving device operate when the power generation electrolysis portion is performing the power generation; and makes the second gas moving device operate when the power generation electrolysis portion is performing the electrolysis.

Besides, in the secondary battery type fuel cell system having the eighth structures, a structure (ninth structure) may be employed, in which when the power generation electrolysis portion is performing the power generation, the gas moving device controller controls the amount of gas-flow produced by the first gas moving device based on the power generation amount of the power generation electrolysis portion; and when the power generation electrolysis portion is performing the electrolysis, the gas moving device controller controls the amount of gas-flow produced by the second gas moving device based on the electrolysis amount of the power generation electrolysis portion.

According to the secondary battery type fuel cell system described above, the amount of gas-flow produced by the gas moving device at the time when the power generation electrolysis portion is performing the electrolysis is controlled to become less than the amount of gas-flow produced by the gas moving device at the time when the power generation electrolysis portion is performing the power generation; accordingly, during the electrolysis period by the power generation electrolysis portion, it is possible to obviate the consumption of wasteful energy for the driving of the gas moving device and to raise the energy efficiency.

### REFERENCE SIGNS LIST

1 fuel generating member
2 fuel cell portion
2A electrolyte membrane
2B fuel electrode
2C air electrode
3, 4 heaters
5, 6 containers
7, 10, 11 pipes
8 pump
9 heat insulating container
12 system controller
13, 14 gas moving devices

1. A secondary battery type fuel cell system comprising:
a fuel generating member that generates a fuel gas by a chemical reaction and is renewable by a reverse reaction of the chemical reaction,
a power generation electrolysis portion that has: a power generating function to perform power generation by using an oxidant gas and the fuel gas supplied from the fuel generating member; and an electrolysis function to electrolyze a product of the reverse reaction which is supplied from the fuel generating member during a renewal period of the fuel generating member,
a gas flow path that circulates a gas between the fuel generating member and the power generation electrolysis portion,
a gas moving device that sends the oxidant gas to the power generation electrolysis portion, and
a gas moving device controller that controls an amount of gas-flow produced by the gas moving device, wherein
when the power generation electrolysis portion is performing electrolysis, an amount of gas-flow produced by the gas moving device is a first amount of gas-flow, and when the power generation electrolysis portion is performing power generation, an amount of gas-flow produced by the gas moving device is a second amount of gas-flow, and
the gas moving device controller performs control such that the first amount of gas-flow becomes more than 0 and less than the second amount of gas-flow.

2. (canceled)

3. (canceled)

4. The secondary battery type fuel cell system according to claim 1, wherein
when the power generation electrolysis portion is performing the electrolysis, the gas moving device controller drives the gas moving device intermittently.

5. The secondary battery type fuel cell system according to claim 4, wherein
the gas moving device controller performs control such that the amount of blown wind during a drive period in the intermittent drive of the gas moving device becomes less than the amount of gas-flow produced by the gas moving device at the time when the power generation electrolysis portion is performing the power generation.

6. The secondary battery type fuel cell system according to claim 5, wherein
the power generation electrolysis portion has an oxidant electrode to which the oxidant gas is supplied, and
the gas moving device controller switches a drive and stop of the gas moving device based on an oxygen concentration in the oxidant electrode.

7. A secondary battery type fuel cell system comprising:
a fuel generating member that generates a fuel gas by a chemical reaction and is renewable by a reverse reaction of the chemical reaction,
a power generation electrolysis portion that has: a power generating function to perform power generation by using an oxidant gas and the fuel gas supplied from the fuel generating member; and an electrolysis function to electrolyze a product of the reverse reaction which is supplied from the fuel generating member during a renewal period of the fuel generating member,
a gas flow path that circulates a gas between the fuel generating member and the power generation electrolysis portion,
a gas moving device that sends the oxidant gas to the power generation electrolysis portion, and
a gas moving device controller that controls an amount of gas-flow produced by the gas moving device, wherein
the gas moving device controller performs control such that an amount of gas-flow produced by the gas moving device at a time when the power generation electrolysis portion is performing electrolysis becomes less than an amount of gas-flow produced by the gas moving device at a time when the power generation electrolysis portion is performing power generation, and
when the power generation electrolysis portion is performing the electrolysis, the gas moving device controller controls the amount of gas-flow produced by the gas moving device based on an electrolysis amount of the power generation electrolysis portion.

8. A secondary battery type fuel cell system comprising:
a fuel generating member that generates a fuel gas by a chemical reaction and is renewable by a reverse reaction of the chemical reaction,
a power generation electrolysis portion that has: a power generating function to perform power generation by using an oxidant gas and the fuel gas supplied from the fuel generating member; and an electrolysis function to electrolyze a product of the reverse reaction which is supplied from the fuel generating member during a renewal period of the fuel generating member,
a gas flow path that circulates a gas between the fuel generating member and the power generation electrolysis portion,
a gas moving device that sends the oxidant gas to the power generation electrolysis portion, and
a gas moving device controller that controls an amount of gas-flow produced by the gas moving device
wherein
the gas moving device controller performs control such that an amount of gas-flow produced by the gas moving device at a time when the power generation electrolysis portion is performing electrolysis becomes less than an amount of gas-flow produced by the gas moving device at a time when the power generation electrolysis portion is performing power generation,
the gas moving device is used as a first gas moving device, and
a second gas moving device, which discharges an oxidant gas generated by electrolysis from the power generation electrolysis portion, is further included,
the first gas moving device is a gas moving device that has a high efficiency at a large amount of blown wind, and the second gas moving device is a gas moving device that has a high efficiency at a small amount of blown wind,
the gas moving device controller also controls an amount of gas-flow produced by the second gas moving device,
makes the first gas moving device operate when the power generation electrolysis portion is performing the power generation, and
makes the second gas moving device operate when the power generation electrolysis portion is performing the electrolysis.

9. The secondary battery type fuel cell system according claim 8, wherein
when the power generation electrolysis portion is performing the power generation, the gas moving device controller controls the amount of gas-flow produced by the first gas moving device based on the power generation amount of the power generation electrolysis portion, and
when the power generation electrolysis portion is performing the electrolysis, the gas moving device controller controls the amount of gas-flow produced by the second gas moving device based on the electrolysis amount of the power generation electrolysis portion.

10. The secondary battery type fuel cell system according to claim 1, wherein
when the power generation electrolysis portion is performing the power generation, the gas moving device controller controls the second amount of gas-flow in accordance with a power generation amount of the power generation electrolysis portion.

11. The secondary battery type fuel cell system according to claim 1, wherein
when the power generation electrolysis portion is performing the electrolysis, the gas moving device controller controls the first amount of gas-flow in accordance with an electrolysis amount of the power generation electrolysis portion.

12. The secondary battery type fuel cell system according to claim 7, wherein
when the power generation electrolysis portion is performing the power generation, the gas moving device controller controls the amount of gas-flow produced by the gas moving device in accordance with a power generation amount of the power generation electrolysis portion.

13. The secondary battery type fuel cell system according to claim 8, wherein
when the power generation electrolysis portion is performing the electrolysis, the gas moving device controller drives the gas moving device intermittently.
